(19) United States
(12) Patent Application Publication
(10) Pub. No.: US 2019/0234588 A1
(43) Pub. Date: Aug. 1, 2019

(54) CURVED IMAGING DEVICE AND METHOD FOR MANUFACTURING SAME

(71) Applicant: KORTEK CORPORATION, INCHEON (KR)

(72) Inventor: Kyoung Chan LEE, Seoul (KR)

(21) Appl. No.: 16/330,113

(22) PCT Filed: Jul. 20, 2017
(86) PCT No.: PCT/KR2017/007838

§ 371 Date: Mar. 4, 2019

(30) Foreign Application Priority Data
Sep. 8, 2016 (KR) 10-2016-0115589

(51) Int. Cl. F21V 15/01; F21V 3/10; F21V 21/30; F21V 7/28; F21V 9/14

(52) U.S. Cl. CPC F21V 15/012; F21V 3/10; F21Y 2115/10; F21V 7/28; F21V 9/14; F21V 21/30

(57) ABSTRACT

A curved imaging device and manufacturing method thereof is provided. The curved imaging device includes a deformable support part which includes a plurality of members rotatably connected to each other and is deformed from a flat shape to a concave shape. A backlight unit is installed at the deformable support part to move together with the deformable support part. An optical panel part is installed at an outer portion of the backlight unit to transmit light generated in the backlight unit and configured to form a curvature due to the deformation of the deformable support part, and a panel part fixed to the optical panel part to be bent together with the optical panel part and through which light which has passed through the optical panel part is transmitted.

### CROSS-REFERENCE TO RELATED APPLICATIONS

This application claims priority to PCT Application No. PCT/KR2017/007838, having a filing date of Jul. 20, 2017, based on KR 10-2016-0115589, having a filing date of Sep. 8, 2016, the entire contents both of which are hereby incorporated by reference.

### FIELD OF TECHNOLOGY

The following relates to a curved imaging device and method of manufacturing the same, and more particularly, to a curved imaging device and method of manufacturing the same capable of manufacturing an imaging device with a desired curvature using a standardized backlight unit.

### BACKGROUND

Generally, display devices have progressed into a form in which they are light but may become larger, and a form of displays has progressed to have a flatter panel and a wider viewing angle such that it is possible to display a higher quality image than the past.

In a flat panel display, an RGB image is received from an external system and is processed in an internal controller to be converted to be suitable for a display panel, and the converted RGB image is supplied to each sector of the display which are divided on a matrix in two dimensions according to timings of a gate driver and a source driver so that an image is displayed on a display surface.

However, in this case, since an eyeball, which is an organ with which a viewer senses an actual screen, has a spherical surface, when the viewer views the screen, a gap between a horopter surface, at which distances from the front of the screen toward both left and right sides are recognized as the same distances, and the display surface of the display gradually increases, and thus a problem occurs in that the realness of the recognized image is degraded even when the screen becomes larger.

To solve such a problem, a curved imaging device with increased viewer immersion has been invented. However, to manufacture an imaging device having a curvature, it is required to develop a backlight unit suitable for each curvature and size, and thus a problem occurs in that the cost and time for the development increase. Therefore, there is a need to improve this.

The known art has been disclosed in Korean Unexamined Patent Application Publication No. 2016-0030629 (Date of Publication: Mar. 21, 2016, Title: Curved display and image processing method thereof).

### SUMMARY

An aspect relates to a curved imaging device and method of manufacturing the same capable of manufacturing an imaging device with a desired curvature using a standardized backlight unit.

A curved imaging device according to embodiments of the present invention includes a deformable support part which includes a plurality of members rotatably connected to each other and is deformed from a flat shape to a concave shape, a backlight unit installed at the deformable support part to move together with the deformable support part, an optical panel part installed at an outer portion of the backlight unit to transmit light generated in the backlight unit and configured to form a curvature due to the deformation of the deformable support part, and a panel part fixed to the optical panel part to be bent together with the optical panel part and through which light which has passed through the optical panel part is transmitted.

The deformable support part may include a support panel part formed in a plate shape and joined to the optical panel part and a plurality of connecting panel parts rotatably installed at the support panel part.

The backlight unit may be installed at each of the support panel part and the connecting panel parts and irradiate light toward the panel part through the optical panel part.

The optical panel part may include at least one of a transparent electrode layer, a light diffusion layer, and a polarizing film layer.

The optical panel part may include a slot-shaped fastening hole part for a fastening bolt, which has passed through the support panel part, to pass therethrough.

A method of manufacturing a curved imaging device according to embodiments of the present invention includes a first operation of forming a flat-shaped deformable support part by connecting a plurality of connecting panel parts between a pair of support panel parts, a second operation of installing a backlight unit in each panel of the deformable support part, a third operation of stacking an optical panel part on an upper portion of the backlight unit to temporarily assemble the optical panel part and the deformable support part, a fourth operation of staking a panel part on the optical panel part, a fifth operation of moving the deformable support part to deform the panel part to a curved shape, and a sixth operation of fixing the optical panel part to the deformable support part and joining a guide part to a side of the optical panel part to maintain the curved shape of the panel part.

In a curved imaging device and method of manufacturing the same according to embodiments of the present invention, since a position of a backlight unit, which is manufactured to be standardized, is changed together with a deformable support part while the backlight unit is fixed to the deformable support part, and a panel part can be deformed to a curved shape, the cost for manufacturing the backlight unit can be reduced.

### BRIEF DESCRIPTION

Some of the embodiments will be described in detail, with reference to the following figures, wherein like designations denote like members, wherein:

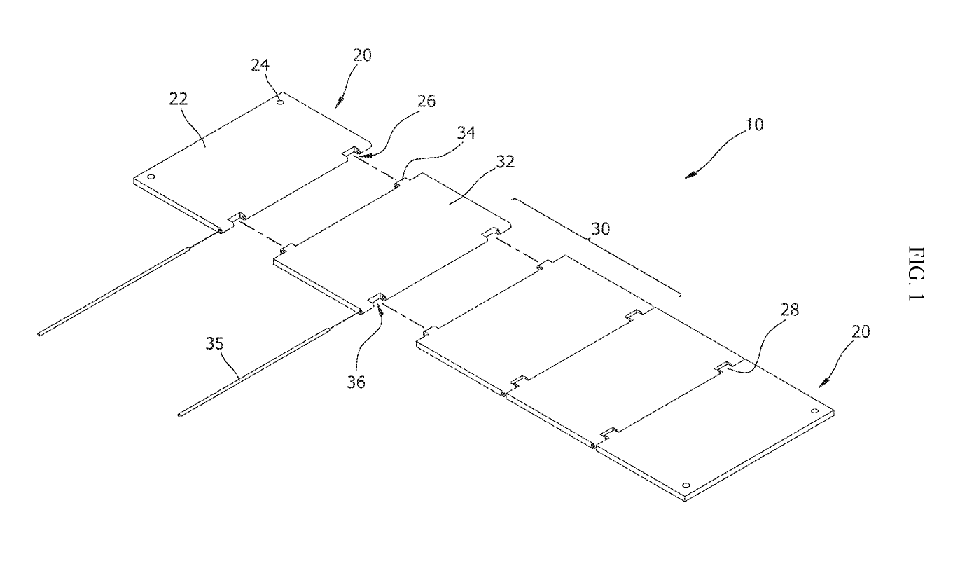

FIG. 1 is a perspective view illustrating a state in which a deformable support part is separated according to an embodiment of the present invention;

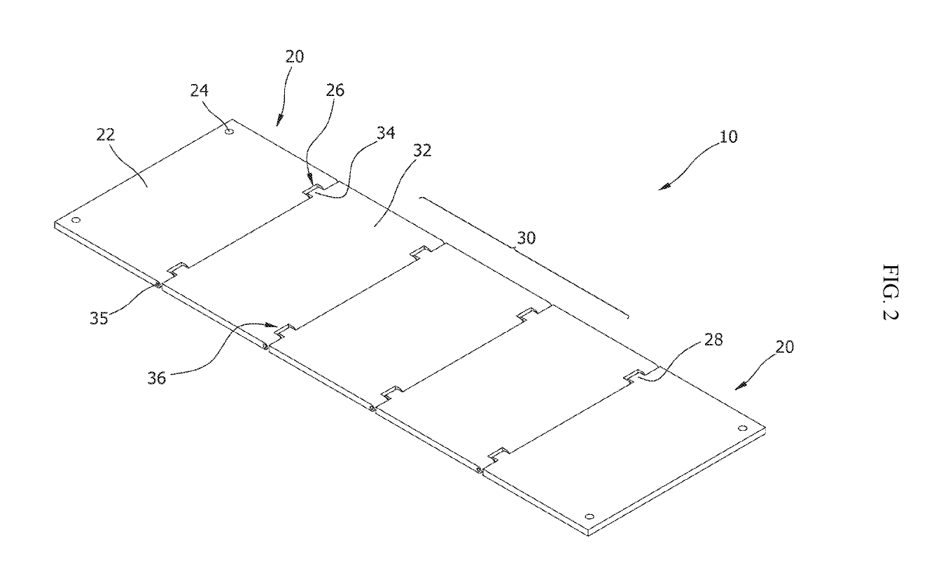

FIG. 2 is a perspective view illustrating a state in which the deformable support part is joined according to an embodiment of the present invention;

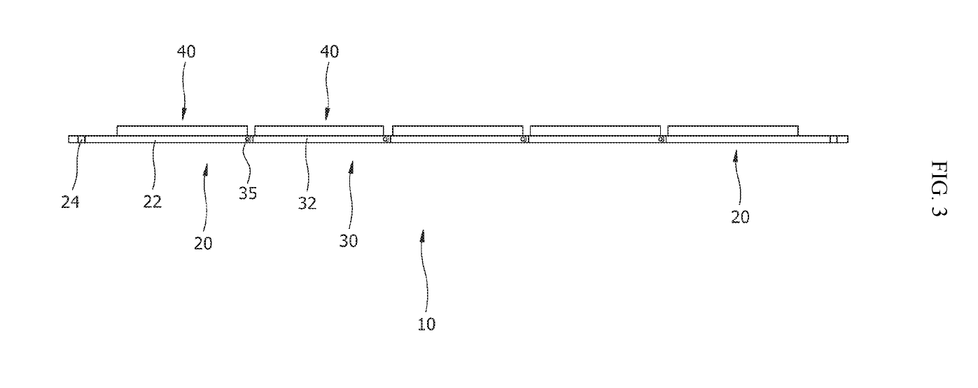

FIG. 3 is a front view illustrating a state in which a backlight unit is joined to the deformable support part according to an embodiment of the present invention;

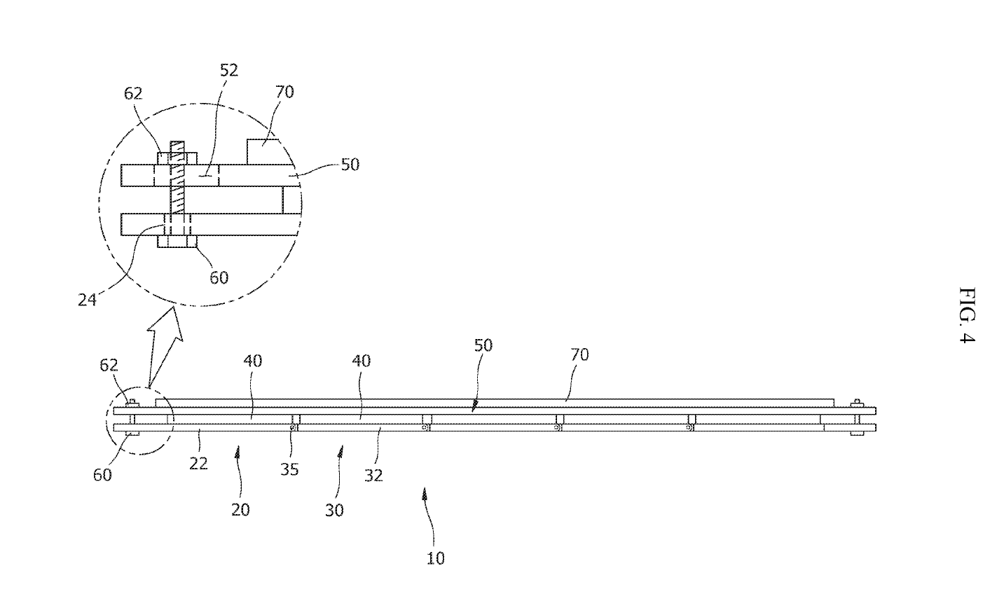

FIG. 4 is a front view illustrating a state in which an optical panel part and a panel part are sequentially stacked in that order on an upper portion of the backlight unit according to an embodiment of the present invention;

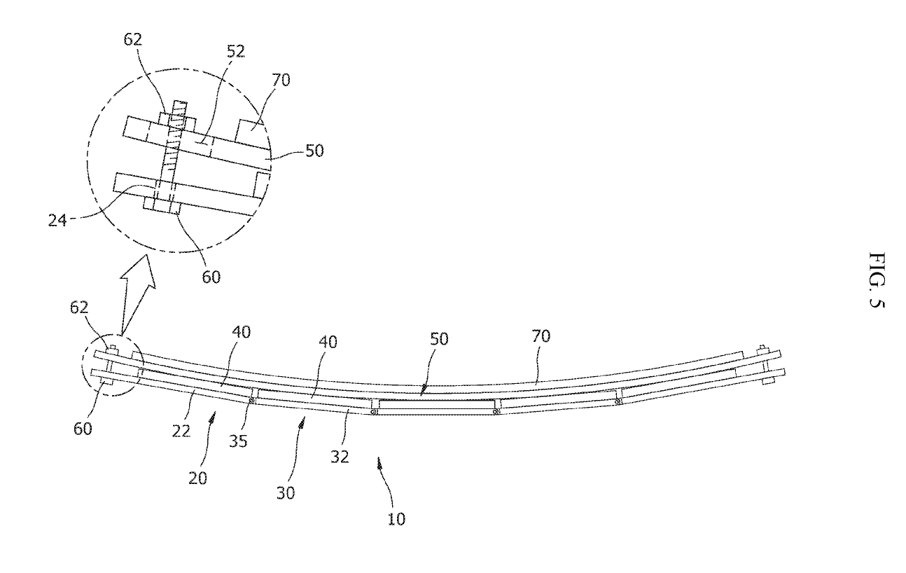

FIG. 5 is a front view illustrating a state in which, as the deformable support part is concavely bent, the panel part also forms a curved surface according to an embodiment of the present invention;

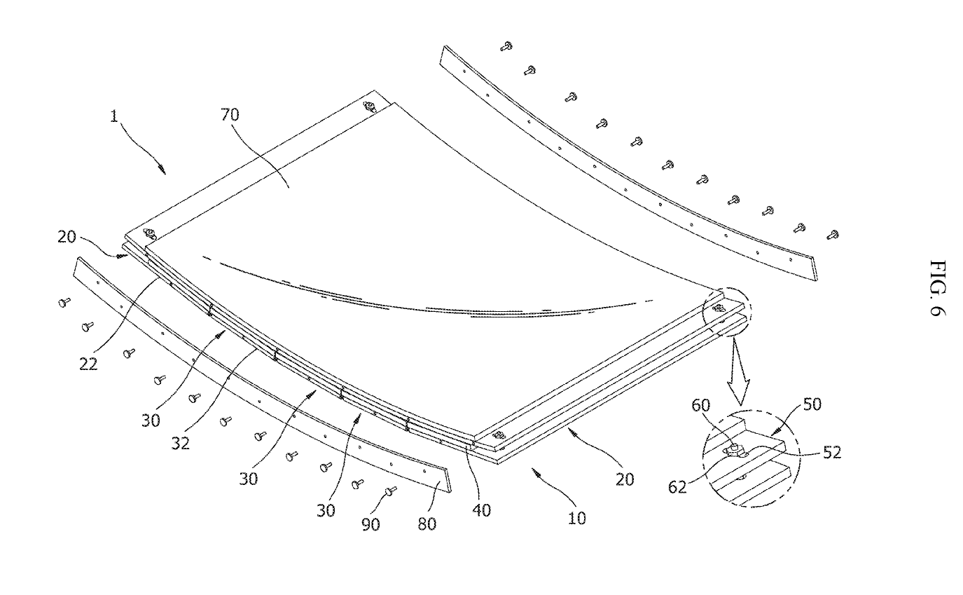

FIG. 6 is a perspective view illustrating a state in which a guide part is installed at both sides of the panel part according to an embodiment of the present invention; and

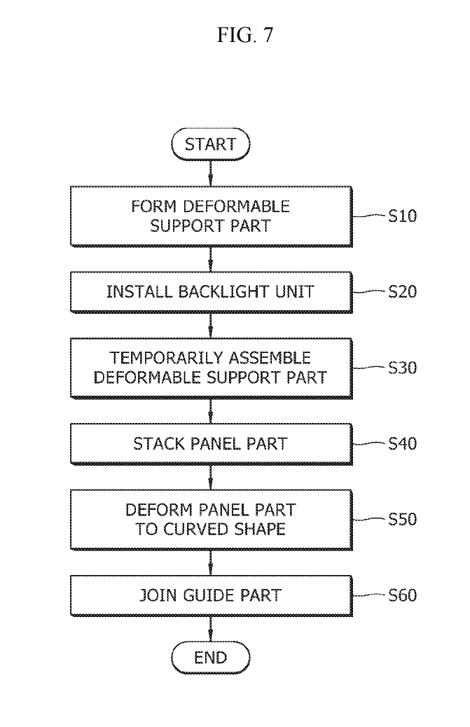

FIG. 7 is a view illustrating a method of manufacturing a curved imaging device according to an embodiment of the present invention.

### DETAILED DESCRIPTION

Hereinafter, a curved imaging device and method of manufacturing the same according to an embodiment of the present invention will be described with reference to the accompanying drawings. In this process, thicknesses of lines, sizes of elements, or the like illustrated in the drawings may have been exaggerated for clarity and convenience of description.

Terms which will be described below are terms defined in consideration of functions in embodiments of the present invention and may vary according to intensions or practices of a user or an operator. Therefore, such terms should be defined on the basis of content throughout the present specification.

FIG. 1 is a perspective view illustrating a state in which a deformable support part is separated according to an embodiment of the present invention; FIG. 2 is a perspective view illustrating a state in which the deformable support part is joined according to an embodiment of the present invention; FIG. 3 is a front view illustrating a state in which a backlight unit is joined to the deformable support part according to an embodiment of the present invention; FIG. 4 is a front view illustrating a state in which an optical panel part and a panel part are sequentially stacked in that order on an upper portion of the backlight unit according to an embodiment of the present invention; FIG. 5 is a front view illustrating a state in which, as the deformable support part is concavely bent, the panel part also forms a curved surface according to an embodiment of the present invention; and FIG. 6 is a perspective view illustrating a state in which a guide part is installed at both sides of the panel part according to an embodiment of the present invention.

As illustrated in FIGS. 4 to 6, a curved imaging device 1 according to an embodiment of the present invention includes a deformable support part 10, a backlight unit 40, an optical panel part 50, a panel part 70, and a guide part 80.

In the curved imaging device 1, a timing controller (TCON) which serves to distribute data to driving drivers is connected to the panel part 70. In a graphic card of the curved imaging device 1, in order to transmit an image signal at a high speed, data is serialized using a high-frequency clock and then sent to the panel part 70. The transmitted signal is received by the TCON of the panel part 70 via a flexible printed circuit board (FPCB), which is a transmission line that connects the graphic card and the panel part 70, and then restored to its original parallel signal form so that the signal is processed to be suitable for a resolution and a scan rate of the panel part 70 and distributed to be transmitted to drive pixels of the panel part 70.

In the curved imaging device 1 according to an embodiment of the present invention, since there are limitations in thickness and curvature deformation of the panel part 70 due to the FPCB which is prone to damage, the shape of the deformable support part 10, at which the backlight unit 40 is installed, may be deformed so that a curvature of the panel part 70 is easily formed while damages to the FPCB are prevented.

As illustrated in FIGS. 1 and 2, the deformable support part 10 may be formed in various shapes within the technical idea in which the deformable support part 10 includes a plurality of plate-shaped members rotatably connected to each other and is deformed from a flat shape to a concave shape.

The deformable support part 10 and the backlight unit 40 form a single support module, and a plurality of members are stacked on such a support module in order to configure a curved imaging device. In the deformable support part 10, plate-shapes materials each having a predetermined size are weaved with each other so that the deformable support part 10 has a certain degree of flexibility.

For example, the deformable support part 10 is formed in the shape of a rectangular plate, and a width and a length of each deformable support part 10 are set in consideration of a size and a curved shape of the panel part 70. When the size of the panel part 70 is small, the deformable support part 10 is formed to have a small size, and when the size of the panel part 70 is large, the deformable support part 10 is also formed to have a large size. In addition, the number of plates constituting the deformable support part 10 is also set in consideration of the size and the curved shape of the panel part 70.

In addition, in the deformable support part 10 in which the plurality of plates are rotatably connected, it is preferable that plates adjacent to each other be rotatably connected within a range from 5° to less than 45° in order to form a curved surface along the panel part. When the angle at which any two plates are installed in the deformable support part 10 is less than 5°, there are a problem in that the production cost is increased due to an increase in the number of plates constituting the deformable support part 10 and a problem in that the size of the panel part 70 is enlarged in order to form a set curvature. In addition, when the angle at which any two plates are installed in the deformable support part 10 is 45° or greater, since a distance at which the panel part 70 and the deformable support part 10 are spaced apart from each other increases, a problem occurs in that the support of the panel part 70 becomes unstable. Therefore, the angle at which any two plates constituting the panel part 70 are installed is limited to the range from 5° to less than 45°.

The deformable support part 10 according to an embodiment includes a support panel part 20 formed in a plate shape and coupled to the optical panel part 50, a plurality of connecting panel parts 30 rotatably installed at the support panel part 20, and a connecting pin member 35 connected to the support panel part 20 and the connecting panel parts 30 to rotatably connect the support panel part 20 and the connecting panel parts 30. The support panel part 20 is disposed at both sides of the deformable support part 10, and the connecting panel parts 30 are disposed between the support panel parts 20.

Since each of the support panel parts 20 and the connecting panel parts 30 are rotatably connected, the deformable support part 10, which is placed in a flat shape upon initial assembly, may be deformed to be concave toward the panel part 70.

The support panel part 20 according to an embodiment includes a support panel body 22, a connecting hole 24, a mounting groove part 26, and a mounting protrusion 28. The support panel body 22 is formed in a plate shape, and the connecting hole 24 for a fastening bolt 60 to pass therethrough is formed at one side of the support panel body 22. In addition, the mounting groove part 26 or the mounting protrusion 28 is formed at a side of the support panel body 22 facing the connecting panel parts 30.

The connecting panel part 30 according to an embodiment includes a connecting panel body 32, a joining protrusion 34, and a joining groove part 36. The connecting panel body 32 is formed in a plate shape, the joining protrusion 34 protrudes from one side of the connecting panel body 32, and the joining groove part 36 is disposed at the other side of the connecting panel body 32.

The joining protrusion 34 of the connecting panel part 30 is inserted into an inner portion of the mounting groove part 26 of the support panel part 20 disposed at one side of the deformable support part 10, or the connecting pin member 35 is inserted into the joining protrusion 34 while the joining protrusion 34 is inserted into the joining groove part 36 of the connecting panel part 30 adjacent thereto so that adjacent members are rotatably connected. In addition, in a state in which the mounting protrusion 28 of the support panel part 20 disposed at the other side of the deformable support part 10 is inserted into the joining groove part 36 of the connecting panel part 30 adjacent thereto, the mounting protrusion 28 and the joining groove part 36 are rotatably connected to each other due to the installation of the connecting pin member 35.

As illustrated in FIG. 3, the backlight unit 40 is installed in the deformable support part 10 to move together with the deformable support part 10, and various types of light emitting devices may be used as the backlight unit 40 within the technical idea in which the backlight unit 40 irradiates light toward the panel part 70. The backlight unit 40 according to an embodiment is installed at each of the support panel part 20 and the connecting panel parts 30 and irradiates light toward the panel part 70 through the optical panel part 50.

Since the backlight unit 40 is fixed to an upper portion of each of the support panel part 20 and the connecting panel parts 30 when a position at which the deformable support part 10 is installed is changed, a position at which the backlight unit 40 is installed is also changed accordingly.

Meanwhile, a reflective sheet may be further installed between the backlight unit 40 and the deformable support part 10. When the reflective sheet is further installed, loss of light of the backlight unit 40 may be reduced so that optical efficiency is increased.

As illustrated in FIGS. 4 to 6, the optical panel part 50 is installed at an outer portion of the backlight unit 40 so that light generated in the backlight unit 40 is transmitted therethrough, and the optical panel part 50 forms a curvature due to the deformation of the deformable support part 10.

Since the deformable support part 10 is formed of a plurality of plates, when the deformable support part 10 is deformed to a concave shape, the deformable support part 10 and the upper portion of the backlight unit 40 attached to the deformable support part 10 inevitably form an angular shape. However, since the optical panel part 50, which has a property of being bendable, is installed at the upper portion of the backlight unit 40, a lower portion of the backlight unit 40 which supports the panel part 70 may maintain a curved shape, and thus damages to the panel part 70 are prevented. In addition, since a gap between the optical panel part 50 and the backlight unit 40 is adjusted to remove a black area, which is a region in which an amount of light is small, the light generated in the backlight unit 40 may be uniformly supplied to the panel part 70.

Meanwhile, optical superposition or a portion with a small amount of light which is formed at a boundary surface of the backlight unit 40 may be adjusted using light emitting diode (LED) arrays disposed in the backlight unit 40. For example, light may be uniformly supplied to the panel part 70 by decreasing the number of LED arrays of backlight units 40 installed at portions adjacent to each other and increasing the number of LED arrays of backlight units 40 installed at portions relatively spaced apart from each other.

The optical panel part 50 according to an embodiment includes a slot-shaped fastening hole part 52 for the fastening bolt 60, which has passed through the support panel part 20, to pass therethrough. The fastening hole part 52 is disposed at both sides of the optical panel part 50 and forms a slot-shaped hole. Therefore, during a curving task in which the panel part 70 is deformed from a flat shape to a curved shape, an operation in which the panel part 70 is pushed may be supplemented. That is, during the curving task, by taking into account that the panel part 70 is pushed, temporary assembly of the fastening bolt 60 and a fastening nut 62 is firstly performed using the fastening hole part 52, which is a slot. Then, when the curving task of the deformable support part 10, the optical panel part 50, and the panel part 70 is completed, a task in which the fastening bolt 60 and the fastening nut 62 are fixed is secondly performed. Since the fastening nut 62 is not completely joined to the fastening bolt 60 in the firstly-performed fixing task, a position at which the fastening bolt 60 is fastened may be changed according to the fastening hole part 52.

The optical panel part 50 according to an embodiment includes at least one of a transparent electrode layer, a light diffusion layer, and a polarizing film layer.

The polarizing film layer, which is referred to as a polaroid (POL) film, is a film having a property capable of distinguishing vertical or horizontal polarization of incident light and allowing the light to pass therethrough or blocking the light.

A light diffusion film is used as the light diffusion layer. The light diffusion layer may diffuse light which is generated in the backlight unit 40 and moved to the panel part 70 to form uniform illumination.

The transparent electrode layer, which is referred to as indium tin oxide (ITO), is a thin layer which is transparent and colorless. ITO is mainly used in forming transparent conductive coating in a liquid crystal display, a flat panel display, a plasma display, a touchscreen, an organic LED, a solar cell, an antistatic coating, and an electromagnetic interference shield.

The joining between the optical panel part 50 and the panel part 70 may also be performed by an adhesive film. The adhesive film referred to as an optically clear adhesive (OCA) is an adhesive which has an excellent antistatic function and has excellent transparency such that an amount of generated static electricity is small and an adherend is not contaminated during separation.

The panel part 70 is fixed to the optical panel part 50 to be bent together with the optical panel part 50, and light which has passed through the optical panel part 50 is transmitted through the panel part 70. The panel part 70 has a flat shape initially. Due to the deformation of the deformable support part 10 to a curved shape, the panel part 70 is also deformed to a curved shape.

In order to prevent the panel part 70, the deformable support part 10, the backlight unit 40, and the like, on which the curving task has been performed, from being restored to their original shapes, the guide part 80 is installed at both left and right sides of the panel part 70 and the deformable support part 10. The guide part 80 is formed in a plate shape and is formed in a curved shape along the panel part 70, the optical panel part 50, and the deformable support part 10, which are curved.

Therefore, since the optical panel part 50 and the deformable support part 10, which have been deformed to a curved shape due to the curving task, are fixed by a fixing bolt 90 while the guide part 80 abuts sides of the optical panel part 50 and the deformable support part 10, the panel part 70, the optical panel part 50, and the like may maintain the curved shape.

Hereinafter, a method of manufacturing the curved imaging device 1 according to an embodiment of the present invention will be described in detail with reference to the accompanying drawings.

FIG. 7 is a view illustrating a method of manufacturing a curved imaging device according to an embodiment of the present invention.

As illustrated in FIGS. 1, 2, and 7, the method of manufacturing the curved imaging device 1 according to an embodiment of the present invention includes a first operation of forming a flat-shaped deformable support part 10 by connecting a plurality of connecting panel parts 30 between a pair of support panel parts 20 (S10).

The support panel parts 20 are disposed at both sides of the deformable support part 10, and while the plurality of connecting panel parts 30 are disposed between the support panel parts 20, a joining protrusion 34 of an adjacent connecting panel part 30 is inserted into a mounting groove part 26 of the support panel part 20, and then the joining protrusion 34 and the mounting groove part 26 are connected using a connecting pin member 35. Then, adjacent connecting members are hinge-connected by inserting the joining protrusion 34 into a joining groove part 36 and then inserting the connecting pin member 35 thereto. In addition, while the mounting protrusion 28 of the support panel part 20 is inserted into the joining groove part 36 of the connecting panel part 30, the connecting pin member 35 is inserted to hinge-connect the support panel part 20 and the connecting panel part 30.

Then, as illustrated in FIGS. 3 and 7, the method includes a second operation of installing a backlight unit 40 in each panel of the deformable support part 10 (S20).

After preparing backlight units 40 as much as the number of the support panel parts 20 and the connecting panel parts 30 of the deformable support part 10, the backlight units 40 are fixed to upper portions of the support panel parts 20 and the connecting panel parts 30.

Then, as illustrated in FIGS. 4 and 7, the method includes a third operation of staking an optical panel part 50 on an upper portion of the backlight unit 40 to temporarily assemble the optical panel part 40 and the deformable support part 10 (S30).

While a fastening bolt 60 is installed to pass through a connecting hole 24 of the deformable support part 10 and a fastening hole part 52 of the optical panel part 50, a fastening nut 62 is temporarily fixed to the fastening bolt 60. In this case, a task of fixing the fastening nut 62 is performed to an extent that the fastening bolt 60 and the fastening nut 62 are movable along the fastening hole part 52, which has the shape of a slot.

In addition, the method includes a fourth operation of stacking a panel part 70 on the optical panel part 50 (S40).

Since the panel part 70 is stacked on an upper portion of the optical panel part 50, during the curving task of the deformable support part 10, an operation in which a corner of the deformable support part 10 or the backlight unit 40 damages a lower portion of the panel part 70 is blocked.

In addition, as illustrated in FIGS. 5 and 7, the method includes a fifth operation of moving the deformable support part 10 to deform the panel part 70 to a curved shape (S50).

Each member of the deformable support part 10 is moved to deform the shape of the deformable support part 10 so that the deformable support part 10 has a concave shape toward the panel part 70 as a whole. The optical panel part 50 which is temporarily assembled to the deformable support part 10 is also bent to a concavely curved shape, and the panel part 70 which is fixed to the optical panel part 50 is also deformed to the curved shape.

In addition, as illustrated in FIGS. 6 and 7, the method includes a sixth operation of fixing the optical panel part 50 to the deformable support part 10 and joining a guide part 80 to a side of the optical panel part 50 to maintain the curved shape of the panel part 70 (S60).

While the curving task has been completed, the fastening nut 62 is fastened to restrict movement of the fastening nut 62 and the fastening bolt 60 along the fastening hole part 52. Then, while the guide part 80 is in contact with both sides of the panel part 70, the guide part 80 and the deformable support part 10 are fixed using a fixing bolt 90 so that the guide part 80 and the deformable support part 10 are fixed.

As described above, according to embodiments of the present invention, since a position of the backlight unit 40, which is manufactured to be standardized, is changed together with the deformable support part 10 while the backlight unit 40 is fixed to the deformable support part 10, and the panel part can be deformed to a curved shape, the cost for manufacturing the backlight unit 40 can be reduced. In addition, since the curving task is simultaneously performed on the panel part 70, the deformable support part 10, and the backlight unit 40, the product defect rate can be decreased. In addition, since the panel part 70 is joined to the deformable support part 10 while the panel part 70 is flat and then the curving task is performed on the panel part 70, it is possible to form a slim structure. In addition, damages to an FPCB can also be prevented during the curving task.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A curved imaging device comprising:
a deformable support part which includes a plurality of members rotatably connected to each other and is deformed from a flat shape to a concave shape;
a backlight unit installed at the deformable support part to move together with the deformable support part;
an optical panel part installed at an outer portion of the backlight unit to transmit light generated in the backlight unit and configured to form a curvature due to the deformation of the deformable support part; and
a panel part fixed to the optical panel part to be bent together with the optical panel part and through which light which has passed through the optical panel part is transmitted.

2. The curved imaging device of claim 1, wherein the deformable support part comprises:
a support panel part formed in a plate shape and joined to the optical panel part; and
a plurality of connecting panel parts rotatably installed at the support panel part.

3. The curved imaging device of claim 2, wherein the backlight unit is installed at each of the support panel part and the connecting panel parts and irradiates light toward the panel part through the optical panel part.

4. The curved imaging device of claim 3, wherein the optical panel part comprises at least one of a transparent electrode layer, a light diffusion layer, and a polarizing film layer.

5. The curved imaging device of claim 3, wherein the optical panel part includes a slot-shaped fastening hole part for a fastening bolt, which has passed through the support panel part, to pass therethrough.

6. A method of manufacturing a curved imaging device, the method comprising:
a first operation of forming a flat-shaped deformable support part by connecting a plurality of connecting panel parts between a pair of support panel parts;
a second operation of installing a backlight unit in each panel of the flat-shaped deformable support part;
a third operation of stacking an optical panel part on an upper portion of the backlight unit to temporarily assemble the optical panel part and the flat-shaped deformable support part;
a fourth operation of stacking a panel part on the optical panel part;
a fifth operation of moving the flat-shaped deformable support part to deform the panel part to a curved shape; and
a sixth operation of fixing the optical panel part to the flat-shaped deformable support part and joining a guide part to a side of the optical panel part to maintain the curved shape of the panel part.
